(19) United States
(12) Patent Application Publication
(10) Pub. No.: US 2007/0147488 A1
(43) Pub. Date: Jun. 28, 2007

(54) Apparatus and method for communication between a digital unit and a remote RF unit in a broadband wireless communication system

(75) Inventor: Kwang-Hee Han, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/646,892

(22) Filed: Dec. 28, 2006

(30) Foreign Application Priority Data
Dec. 28, 2005 (KR) 2005-132168

(51) Int. Cl. H04L 5/16

(52) U.S. Cl. 375/222

(57) ABSTRACT

Provided are an apparatus and method for communication between a digital unit and a remote radio frequency unit in a broadband wireless communication system. A frame structure of Inphase/Quadrature (IQ) sample data based on various channel bandwidths and sampling frequencies is defined, and then the IQ sample data are generated in the frame. The digital unit transmits the IQ sample data into the remote Radio Frequency (RF) unit, and then the remote RF unit reconstructs the frame by using the received IQ sample data from the digital unit.

### PRIORITY

This application claims priority under 35 U.S.C. §119 to an application entitled “Apparatus And Method For Communication Between Digital Unit And Remote RF Unit In Broadband Wireless Communication System” filed in the Korean Intellectual Property Office on Dec. 28, 2005 and allocated Serial No. 2005-132168, the contents of which are incorporated herein by reference.

### BACKGROUND OF THE INVENTION

1. Field of the Invention

The present invention relates generally to a frame structure of Inphase/Quadrature (IQ) sample data based on various channel bandwidths and sampling frequencies, and an apparatus and method for communication between a digital unit and a remote Radio Frequency (RF) unit in a broadband wireless communication system.

2. Description of the Related Art

A base station includes a Digital Unit (DU) processing a baseband, and an RF unit processing an RF analogue wireless signal. That is, the digital unit and the RF unit are included in the base station. The digital unit and the RF unit can be included in one unit, and can also be separatedly located from each other. A remote RF unit is where the RF unit is separated from and controlled by the digital unit, and one digital unit may include a plurality of remote RF units.

In a third generation wireless communication system, when at least one remote RF unit connected to one digital unit is located in a base station, the digital unit and the remote RF unit are connected using an optical cable, and Common Public Radio Interface (CPRI) standard such as IQ sample data, synchronization information, etc. are defined and used for communication between the digital unit and the remote RF unit, and one remote RF unit and another remote RF unit in a separated structure.

Since the third generation wireless communication system includes a chip rate of 3.84 MHz, the CPRI standard uses a frame structure based on a clock cycle having an integer multiple of 3.84 MHz for transmitting/receiving an IQ sample data between the digital unit and the remote RF unit. However, an Institute of Electrical and Electronics Engineers (IEEE) 802.16 system of a broadband wireless communication system requires various channel bandwidths such as 4.375 MHz, 5 MHz, 8.75 MHz, 10 MHz, 17.5 MHz, and 20 MHz, and each sampling frequency of the various channel bandwidths varies. Since the remote RF unit extracts a system clock corresponding to an integer multiple of the sampling frequency, from the IQ sample data, frequency converting units are required in the digital unit and the remote RF unit, respectively to apply conventional CPRI standards to a broadband wireless communication system. However, adding the clock converting unit may increase a system expense and complexity.

Accordingly, required are an apparatus and method for communication through a frame structure of an IQ sample data capable of communicating in a broadband wireless communication system without a clock converting device.

### SUMMARY OF THE INVENTION

An object of the present invention is to substantially solve at least the above problems and/or disadvantages and to provide at least the advantages below. Accordingly, an object of the present invention is to provide an apparatus and a method for communication between a digital unit and a remote RF unit in a base station of a broadband wireless communication system.

Another object of the present invention is to provide an apparatus and method for communication between a digital unit of a base station and an RF unit in a frame structure considering a system clock.

Still another object of the present invention is to provide a frame structure of an IQ sample data considering various channel bandwidths and sampling frequencies in a broadband wireless communication system.

According to an aspect of the present invention, there is provided a digital unit in a base station, the digital unit includes: a clock generating unit for generating a system clock to supply the system clock into a modem unit and an Intermediate Frequency (IF) unit; the modem unit for generating IQ sample data in synchronization with the received system clock and for transmitting the IQ sample data into the IF unit; and the IF unit for generating a predetermined frame using the IQ sample data from the modem unit according to the system clock received from the clock generating unit, encoding the frame from 8 bits to 10 bits, and serializing as well as transmitting the encoded frame into a remote radio unit.

According to another aspect of the present invention, there is provided a remote radio unit in a base station that includes an IF unit for parallelizing a signal received from a digital unit in the base station, decoding the signal from 10 bits to 8 bits, and reconstructing a predetermined frame structure using the decoded signal.

According to still another aspect of the present invention, there is provided a method for communication from a digital unit to a remote radio unit in a base station, the method includes: generating a system clock; generating IQ sample data in synchronization with the system clock; generating a predetermined frame according to the system clock; encoding the frame from 8 bits to 10 bits; serializing the encoded signal; and transmitting the serialized signal into a remote RF unit.

According to still another aspect of the present invention, there is provided a method for communication from a remote radio unit to a digital unit in a base station, the method includes: receiving a serialized signal from the digital unit; parallelizing the received signal; decoding the parallelized signal from 10 bits into 8 bits; and reconstructing a predetermined frame using the decoded signal.

### BRIEF DESCRIPTION OF THE DRAWINGS

The above and other objects, features and advantages of the present invention will become more apparent from the following detailed description when taken in conjunction with the accompanying drawings in which:

FIG. 1A is a diagram illustrating a frame structure of an Inphase/Quadrature (IQ) sample data of a wireless communication system having a channel bandwidth of 10 MHz according to the present invention;

FIG. 1B is a diagram illustrating a frame structure of IQ sample data of a wireless communication system having a channel bandwidth of 8.75 MHz according to the present invention;

FIG. 2A is a diagram illustrating a frame structure including an over-sampled IQ sample data of a wireless communication system having a channel bandwidth of 10 MHz according to the present invention;

FIG. 2B is a diagram illustrating a frame structure excluding over-sampled IQ sample data of a wireless communication system having a channel bandwidth of 10 MHz according to the present invention;

FIG. 3A is a frame structure of IQ sample data in a wireless communication system including a channel bandwidth of 5 MHz according to the present invention;

FIG. 3B is a diagram illustrating a frame structure of IQ sample data in a wireless communication system including a channel bandwidth of 4.375 MHz according to the present invention;

FIG. 4A is a diagram illustrating a frame structure of IQ sample data of a wireless communication system having a channel bandwidth of 20 MHz according to the present invention;

FIG. 4B is a diagram illustrating a frame structure of IQ sample data of a wireless communication system having a channel bandwidth of 17.5 MHz according to the present invention;

FIG. 5 is a diagram illustrating a structure of a 5 ms radio frame according to the present invention;

FIG. 6 is a diagram illustrating a structure of a sub-channel in a hyperframe according to the present invention;

FIG. 7 is a diagram illustrating an apparatus for communication between a digital unit of a base station and a remote RF unit in a frame structure according to the present invention; and

FIG. 8 is a flowchart illustrating a communication flow between a digital unit of a base station and a remote RF unit in a frame structure according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, the present invention defines a frame structure of IQ sample data based on a sampling frequency of various channel bandwidths in a broadband wireless communication system. Additionally, an object of the present invention is to provide an apparatus and method for communication between a digital unit of a base station and a remote (radio frequency) RF unit. The digital unit generates the IQ sample data in the frame structure and transmits the IQ sample data into the remote RF unit. The base station reconstructs the frame structure by using the received IQ sample data.

The Institute of Electrical and Electronics Engineers (IEEE) 802.16 system of the broadband wireless communication system includes various channel broadbandwidths such as 4.37 MHz, 5 MHz, 8.75 MHz, 10 MHz, 17.5 MHz, and 20 MHz, etc. Sampling frequencies according to each of the channel bandwidths are illustrated in Table 1 below.

TABLE 1

| Channel bandwidth | | Sampling frequency | |
|---|---|---|---|
| 4.375 | MHz | 5 | MHz |
| 5 | MHz | 5.6 | MHz |
| 8.75 | MHz | 10 | MHz |
| 10 | MHz | 11.2 | MHz |
| 17.5 | MHz | 15 | MHz |
| 20 | MHz | 22.4 | MHz |

Referring to Table 1, the channel bandwidths can largely be divided into a 5 MHz series having channel bandwidths of 4.375 MHz, 8.75 MHz, and 17.5 MHz, of which the sampling frequency is an integer multiplicity of 5 MHz, and a 5.6 MHz series having channel bandwidths of 5 MHz, 10 MHz, and 20 MHz, of which the sampling frequency is an integer multiplicity of 5.6 MHz.

In the wireless communication system, a system clock uses over four times of the sampling frequency for transmission and reception of IQ sample data. A system clock of which a sampling frequency is a 5.6 MHz series is assumed as 56 MHz, which is five times of an 11.2 MHz sampling frequency corresponding to a 10 MHz channel bandwidth. A system clock of which a sampling frequency is a 5 MHz series is assumed as 50 MHz, which is five times of a 10 MHz sampling frequency corresponding to an 8.75 MHz channel bandwidth.

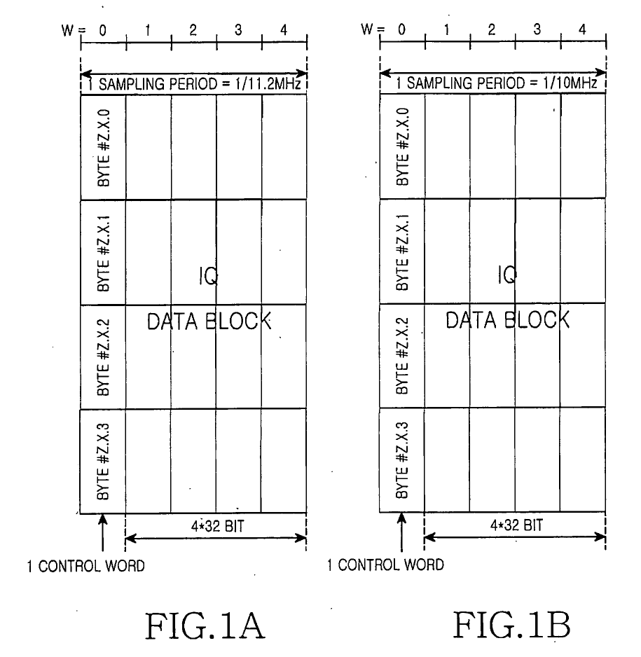

The IQ sample data structure according to the channel bandwidth will be described with reference to FIGS. 1 through 4.

A frame structure of the IQ sample data in a wireless communication system having 10 MHz and 8.75 MHz channel bandwidths are described below with reference to FIGS. 1A and 1B.

FIG. 1A is a diagram of a frame structure of IQ sample data of a wireless communication system having a channel bandwidth of 10 MHz according to the present invention. Referring to FIG. 1A, when the base station has a 10 MHz channel bandwidth, the predetermined frame structure includes sample data including at least one control word and respectively four IQ data with 8 bits during a sampling period of 1/11.2 MHz, and up to a four times oversampling ratio is possible.

The control word includes four control bytes when all control bytes in one frame are four times oversampled as illustrated in FIG. 1(A).

FIG. 1B is a diagram of a frame structure of IQ sample data of a wireless communication system having a channel bandwidth of 8.75 MHz according to the present invention.

Referring to FIG. 1B, when the base station has a 8.75 MHz channel bandwidth, the predetermined frame structure includes sample data including at least one control word and respectively four IQ data with 8 bits during a sampling period of 1/10 MHz, and up to a four times oversampling ratio is possible.

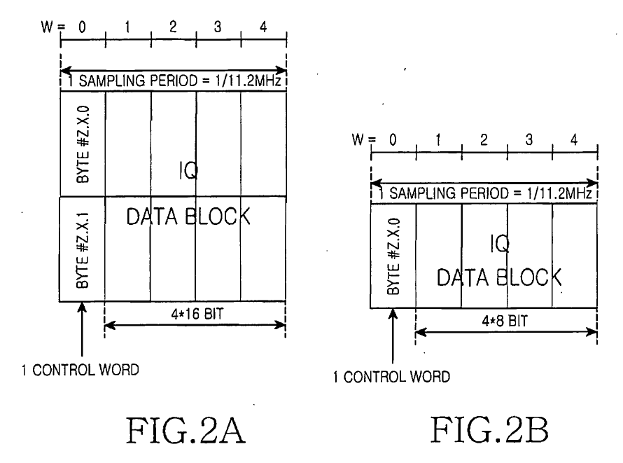

Referring to FIGS. 1A and 1B, a frame structure includes the sample data that are four times oversampled, and a link rate can be changed by adjusting a number of oversamplings, which will be described with reference to FIGS. 2A and 2B.

FIG. 2A is a diagram illustrating a frame structure including an over-sampled IQ sample data of a wireless communication system having a channel bandwidth of 10 MHz according to the present invention.

FIG. 2B is a diagram illustrating a frame structure excluding an over-sampled IQ sample data of a wireless communication system having a channel bandwidth of 10 MHz according to the present invention.

Referring to FIG. 2A, a frame structure includes the IQ sample data of FIG. 1A that are twice oversampled, and has a link rate of 1.12 Gbps. Referring to FIG. 2B, a frame structure includes the IQ sample data of FIG. 1A that are not oversampled, and has a link rate of 560 Mbps.

A wireless communication system having an 8.75 MHz channel bandwidth of FIG. 1B may adjust a link rate by adjusting oversampling as illustrated in FIG. 2B.

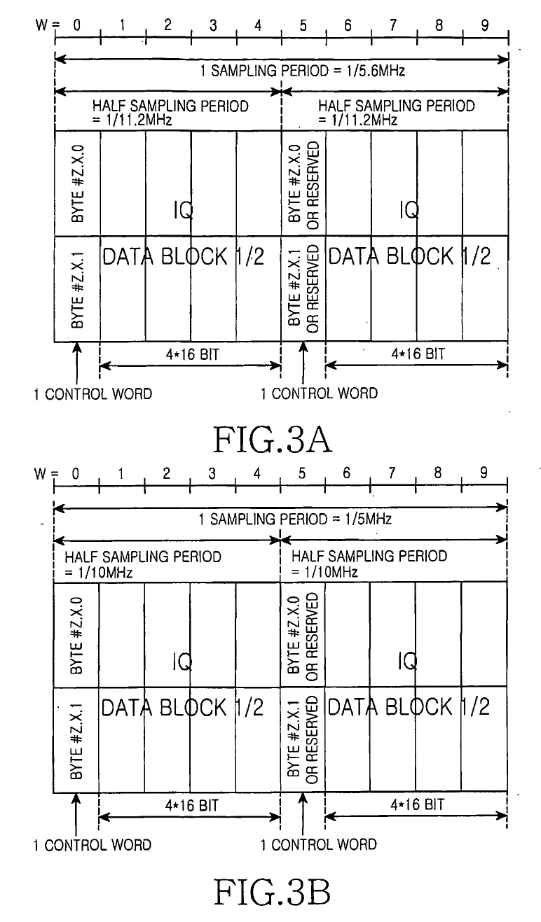

A frame structure of the IQ sample data in a wireless communication system having 5 MHz and 4.375 MHz channel bandwidths are described below with reference to FIGS. 3A and 3B.

FIG. 3A is a diagram illustrating a frame structure of an IQ sample data in a wireless communication system including a channel bandwidth of 5 MHz according to the present invention.

Referring to FIG. 3A, when the base station has a 5 MHz channel bandwidth, the predetermined frame structure includes two consecutive sample data including one control word and respectively four IQ data with 8 bits during a sampling period of 1/5.6 MHz, and up to a four times oversampling ratio is possible.

Referring to FIG. 3B, a four times oversampled frame structure includes four IQ sample data.

FIG. 3B is a diagram of a frame structure of IQ sample data in a wireless communication system including a channel bandwidth of 4.375 MHz according to the present invention.

Referring to FIG. 3B, when the base station has a 4.375 MHz channel bandwidth, the predetermined frame structure includes two consecutive sample data including one control word and respectively four IQ data with 8 bits during a sampling period of 1/5 MHz, and up to a four times oversampling ratio is possible.

Referring to FIG. 3B, a four times oversampled frame structure includes four IQ sample data.

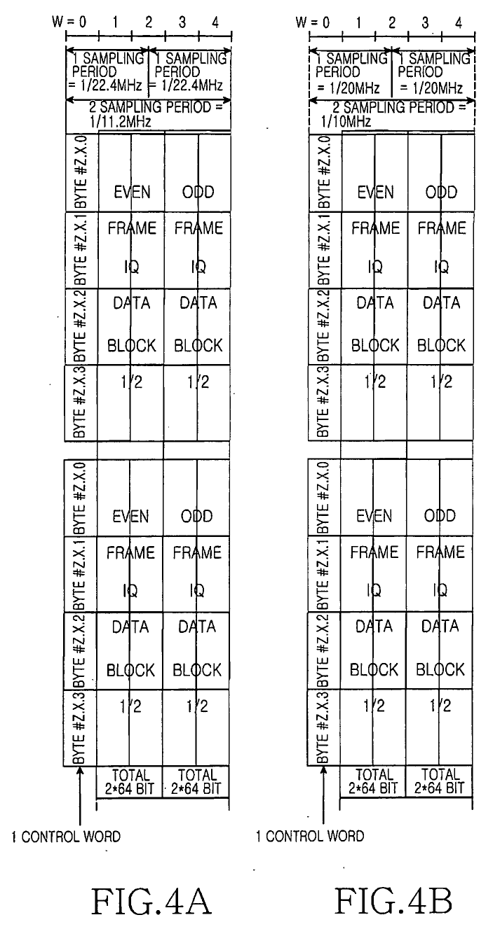

A frame structure of IQ sample data in a wireless communication system having 20 MHz and 17.5 MHz channel bandwidths are described below with reference to FIGS. 4A and 4B.

FIG. 4A is a diagram of a frame structure of IQ sample data of a wireless communication system having a channel bandwidth of 20 MHz according to the present invention.

Referring to FIG. 4A, when the base station has a 20 MHz channel bandwidth, the predetermined frame structure includes two frames including consecutive sample data during one control word and respectively four IQ data with 8 bits during two 1/5 MHz sampling periods, the IQ data in each of the frame including IQ data corresponding to even frames and IQ data corresponding to odd frames, and up to a four times oversampling ratio is possible.

Referring to FIG. 4A, a four time oversampled frame structure includes two frames.

FIG. 4B is a diagram illustrating a frame structure of an IQ sample data of a wireless communication system having a channel bandwidth of 17.5 MHz according to the present invention.

Referring to FIG. 4B, when the base station has a 17.5 MHz channel bandwidth, the predetermined frame structure includes two frames including sample data having one control word and respectively four IQ data with 8 bits during two 1/20 MHz sampling periods, the IQ data in each of the frame including the IQ data corresponding to even frames and IQ data corresponding to odd frames, and up to a four times oversampling ratio is possible.

Referring to FIG. 4B, a four time oversampled frame structure includes two frames.

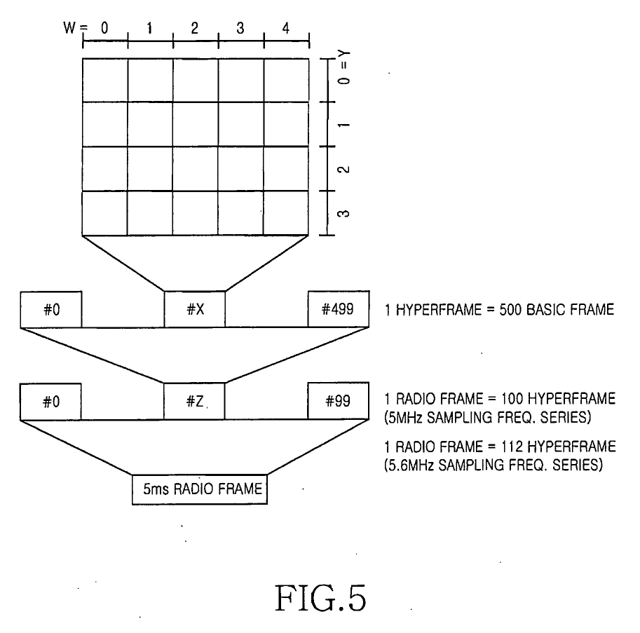

Alternatively, an IEEE 802.16 system of a broadband wireless communication system uses a 5 ms radio frame, is described below with reference to FIG. 5.

FIG. 5 is a diagram illustrating a structure of a 5 ms radio frame according to the present invention.

Referring to FIG. 5, one 5 ms radio frame includes 50,000 frames in a case of a frame of a 5 MHz series sampling frequency, and includes 56,000 frames in a case of a frame of a 5.6 MHz series sampling frequency.

One hyperframe includes 500 basic frames and there are 100 hyperframes in a case of the 5 MHz series sampling frequency. One hyperframe includes 500 basic frames and there are 112 hyperframes in a case of the 5.6 MHz series sampling frequency.

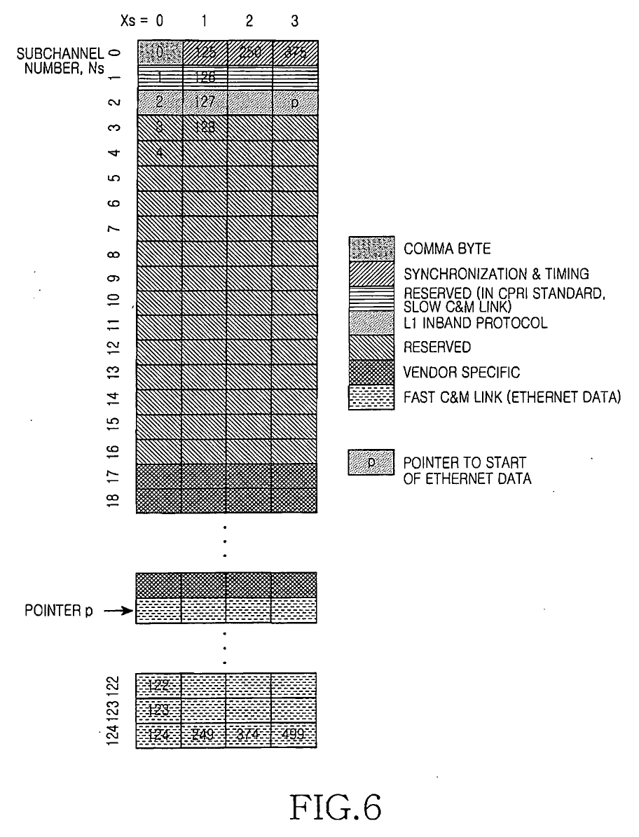

The 500 control words in one hyperframe are grouped by four to constitutes 125 subchannels. Protocol assigned to the subchannel is described below with reference to FIG. 6.

FIG. 6 is a diagram illustrating a structure of a sub-channel in a hyperframe according to the present invention.

Referring to FIG. 6, one hyperframe includes 125 subchannels, and each subchannel includes four control words. The number of subchannels of the hyperframe, defined in a communication protocol (e.g., a CPRI standard) of a third wireless communication system, is 64, but the present invention includes an additional 61 subchannels.

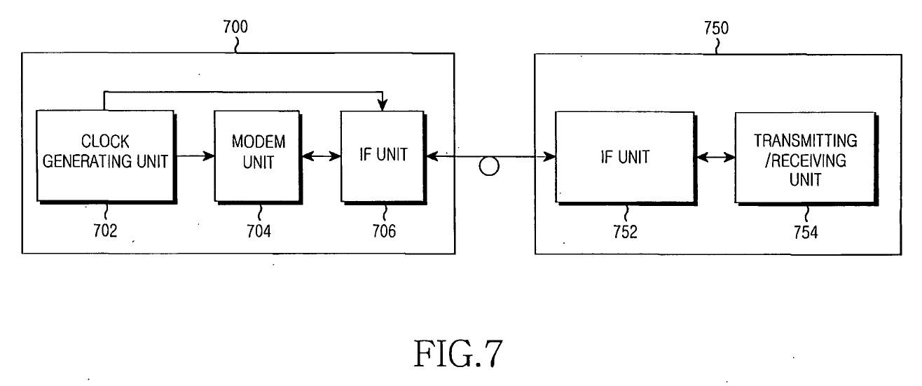

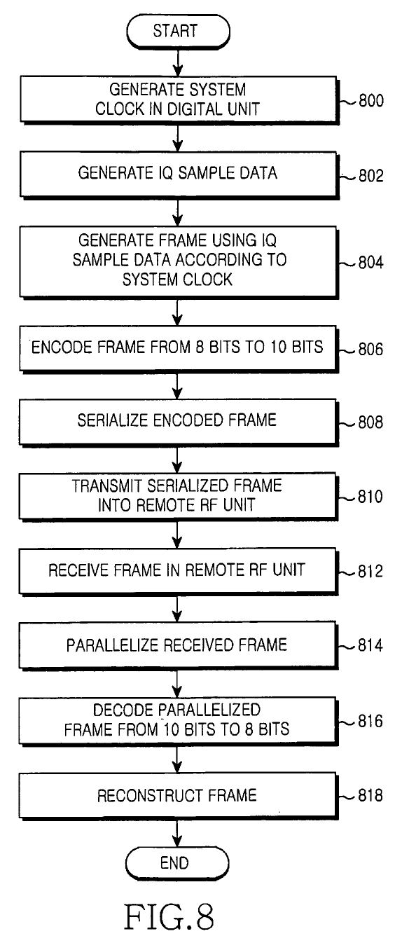

An apparatus and method for communicating IQ sample data of the frame structure through a digital unit and a remote RF unit are described below with reference to FIGS. 7 and 8.

FIG. 7 is a diagram illustrating an apparatus for communication between a digital unit of a base station and a remote RF unit in a frame structure according to the present invention.

Referring to FIG. 7, the base station includes a digital unit 700 and a remote RF unit 750. The digital unit 700 includes a clock generating unit 702, a modem unit 704, and Intermediate Frequency (IF) unit. The remote RF unit 750 includes an IF unit 752 and a transmitting/receiving unit 754.

The clock generating unit 702 of the digital unit 700 generates a system clock, which is an integer multiple of a sampling frequency, and supplies the system clock into the modem unit 704 and the IF unit 706.

The modem unit 704 of the digital unit 700 generates an IQ sample data in synchronization with the received system clock, and then supplies the IQ sample data into the IF unit 706.

The IF unit 706 of the digital unit 700 generates a frame using the IQ sample data received from the modem unit 704 according to a system clock, and encodes the frame from 8 bits to 10 bits and serializes the frame. Then, the IF unit 706 transmits the frame into the remote RF unit 750.

The IF unit 752 of the remote RF unit 750 parallelizes the signal received from the digital unit 700, decodes the signal from 10 bits to 8 bits, and reconstructs a frame by using the signal. Then, the IF unit 752 supplies the frame into the transmitting/receiving unit 754.

The transmitting/receiving unit 754 of the remote RF unit 750 receives the IQ sample data in the received frame from the IF unit 752, and performs operations of a conventional transmitting/receiving unit. As such, description for operations of the transmitting/receiving unit 754 will be omitted for conciseness.

Hereinafter, a method for communicating an IQ sample data in the frame structure of the digital unit and the remote RF unit in a base station are described below with reference to FIG. 8.

FIG. 8 is a flowchart illustrating a communication flow between a digital of a base station and a remote RF unit in a frame structure according to the present invention.

The digital unit of the base station generates a system clock in step 800, generates IQ sample data in synchronization with the system clock in step 802, generates a frame using the IQ sample data according to the system clock in step 804, encodes the frame from 8 bits to 10 bits in step 806, serializes the encoded frame in step 808, and then transmits the serialized signal into the remote RF unit in step 810.

The RF unit of the base station receives the serialized signal from the digital unit in step 812, parallelizes the signal in step 814, decodes the signal from 10 bits to 8 bits in step 816, and reconstructs a frame by using the decoded signal in step 818.

As described above, provided is a frame structure of an IQ sample data based on various channel bandwidths and sampling frequency in a broadband wireless communication system. The present invention provides an apparatus and method for communication between a digital unit and a remote RF unit. Provided are an apparatus and method for communication without a clock converting unit for a frame structure to reduce a system expense and a system complexity.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A digital unit in a base station, the digital unit comprising:
a clock generating unit for generating a system clock to supplied into a modem unit and an Intermediate Frequency (IF) unit;
the modem unit for generating an Inphase Quadrature (IQ) sample data in synchronization with the received system clock and transmitting the IQ sample data into the IF unit; and
the IF unit for generating a frame using the IQ sample data from the modem unit according to the system clock received from the clock generating unit, encoding the frame from 8 bits to 10 bits, and serializing and transmitting the encoded frame into a remote radio unit.

2. The digital unit of claim 1, wherein the system clock is an integer multiple of a sampling frequency.

3. The unit of claim 1, wherein, when the base station has a 10 MHz channel bandwidth, the frame comprises sample data including at least one control word and four IQ data with 8 bits during a sampling period of 1/11.2 MHz.

4. The unit of claim 1, wherein, when the base station has a 8.75 MHz channel bandwidth, the frame comprises sample data including at least one control word and four IQ data with 8 bits during a sampling period of 1/10 MHz.

5. The unit of claim 1, wherein, when the base station has a 5 MHz channel bandwidth, the frame comprises two consecutive sample data including one control word and four IQ data with 8 bits during a sampling period of 1/5.6 MHz.

6. The unit of claim 1, wherein, when the base station has a 4.375 MHz channel bandwidth, the frame comprises two consecutive sample data including one control word and four IQ data with 8 bits during a sampling period of 1/5 MHz.

7. The unit of claim 1, wherein, when the base station has a 20 MHz channel bandwidth, the frame comprises two frames including consecutive sample data during one control word and four IQ data with 8 bits during two 1/5 MHz sampling periods, the IQ data in each of the frame including IQ data corresponding to even frames and IQ data corresponding to odd frames.

8. The unit of claim 1, wherein, when the base station has a 17.5 MHz channel bandwidth, the frame comprises two frames including sample data having one control word and four IQ data with 8 bits during two 1/20 MHz sampling periods, the IQ data in each of the frame including IQ data corresponding to even frames and IQ data corresponding to odd frames.

9. The unit of claim 1, wherein all the control bytes in the frame are a control word.

10. The unit of claim 1, wherein frames are grouped by 500 to constitute a hyperframe, and 500 control words are grouped by four to constitutes 125 subchannels.

11. A remote radio unit in a base station, the remote radio unit comprising: an Intermediate Frequency (IF) unit parallelizing a signal received from a digital unit in the base station, decoding the signal from 10 bits to 8 bits, and reconstructing a predetermined frame structure using the decoded signal.

12. The unit of claim 11, wherein, when the base station has a 10 MHz channel bandwidth, the frame comprises sample data including at least one control word and four Inphase/Quadrature (IQ) data with 8 bits during a sampling period of 1/11.2 MHz.

13. The unit of claim 11, wherein, when the base station has a 8.75 MHz channel bandwidth, the frame comprises sample data including at least one control word and four Inphase/Quadrature (IQ) data with 8 bits during a sampling period of 1/10 MHz.

14. The unit of claim 11, wherein, when the base station has a 5 MHz channel bandwidth, the frame comprises two consecutive sample data including one control word and four Inphase/Quadrature (IQ) data with 8 bits during a sampling period of 1/5.6 MHz.

15. The unit of claim 11, wherein, when the base station has a 4.375 MHz channel bandwidth, the frame comprises two consecutive sample data including one control word and four Inphase/Quadrature (IQ) data with 8 bits during a sampling period of 1/5 MHz.

16. The unit of claim 11, wherein, when the base station has a 20 MHz channel bandwidth, the frame comprises two frames including consecutive sample data during one control word and four Inphase/Quadrature (IQ) data with 8 bits during two 1/5 MHz sampling periods, the IQ data in each of the frame including IQ data corresponding to even frames.

17. The unit of claim 11, wherein, when the base station has a 17.5 MHz channel bandwidth, the frame comprises two frames including sample data having one control word and four Inphase/Quadrature (IQ) data with 8 bits during two 1/20 MHz sampling periods, the IQ data in each of the frame including IQ data corresponding to even frames and IQ data odd frames.

18. The unit of claim 11, wherein all the control bytes in the frame are a control word.

19. The unit of claim 11, wherein frames are grouped by 500 to constitute a hyperframe, and 500 control words are grouped by four to constitutes 125 subchannels.

20. A method for communication from a digital unit to a remote radio unit in a base station, the method comprising:
generating a system clock;
generating Inphase/Quadrature (IQ) sample data in synchronization with the system clock;
generating a frame according to the system clock;
encoding the frame from 8 bits to 10 bits;
serializing the encoded signal; and
transmitting the serialized signal to a remote Radio Frequency (RF) unit.

21. The method of claim 20, wherein the system clock is an integer multiple of a sampling frequency.

22. The method of claim 20, wherein, when the base station has a 10 MHz channel bandwidth, the frame comprises sample data including at least one control word and four IQ data with 8 bits during a sampling period of 1/11.2 MHz.

23. The method of claim 20, wherein, when the base station has a 8.75 MHz channel bandwidth, the frame comprises sample data including at least one control word and four IQ data with 8 bits during a sampling period of 1/10 MHz.

24. The method of claim 20, wherein, when the base station has a 5 MHz channel band width, the frame comprises two consecutive sample data including one control word and four IQ data with 8 bits during a sampling period of 1/5.6 MHz.

25. The method of claim 20, wherein, when the base station has a 4.375 MHz channel bandwidth, the frame comprises two consecutive sample data including one control word and four IQ data with 8 bits during a sampling period of 1/5 MHz.

26. The method of claim 20, wherein, when the base station has a 20 MHz channel bandwidth, the frame comprises two consecutive sample data including one control word and four IQ data with 8 bits during two 1/5 MHz sampling periods, the IQ data in each of the frame including IQ data corresponding to even frames.

27. The method of claim 20, wherein, when the base station has a 17.5 MHz channel bandwidth, the frame comprises two frames including sample data having one control word and four IQ data with 8 bits during two 1/20 MHz sampling periods, the IQ data in each of the frame including IQ data corresponding to even frames and IQ data odd frames.

28. The method of claim 20, wherein all the control bytes in the frame are a control word.

29. The method of claim 20, wherein frames are grouped by 500 to constitute a hyperframe, and 500 control words are grouped by four to constitutes 125 subchannels.

30. A method for communication from a remote radio unit to a digital unit in a base station, the method comprising:
receiving a serialized signal from the digital unit;
parallelizing the received signal;
decoding the parallelized signal from 10 bits into 8 bits; and
reconstructing a frame using the decoded signal.

31. The method of claim 30, wherein, when the base station has a 10 MHz channel bandwidth, the frame comprises sample data including at least one control word and four Inphase/Quadrature (IQ) data with 8 bits during a sampling period of 1/11.2 MHz.

32. The method of claim 30, wherein, when the base station has a 8.75 MHz channel bandwidth, the frame comprises sample data including at least one control word and four Inphase/Quadrature (IQ) data with 8 bits during a sampling period of 1/10 MHz.

33. The method of claim 30, wherein, when the base station has a 5 MHz channel band width, the frame comprises two consecutive sample data including one control word and four Inphase/Quadrature (IQ) data with 8 bits during a sampling period of 1/5.6 MHz.

34. The method of claim 30, wherein, when the base station has a 4.375 MHz channel band width, the frame comprises two consecutive sample data including one control word and four Inphase/Quadrature (IQ) data with 8 bits during a sampling period of 1/5 MHz.

35. The method of claim 30, wherein, when the base station has a 20 MHz channel band width, the frame comprises two consecutive sample data including one control word and four Inphase/Quadrature (IQ) data with 8 bits during two 1/5 MHz sampling periods, the IQ data in each of the frame including IQ data corresponding to even frames.

36. The method of claim 30, wherein, when the base station has a 17.5 MHz channel band width, the frame comprises two frames including sample data having one control word and four Inphase/Quadrature (IQ) data with 8 bits during two 1/20 MHz sampling periods, the IQ data in each of the frame including IQ data corresponding to even frames.

37. The method of claim 30, wherein all the control bytes in the frame are a control word.

38. The method of claim 30, wherein frames are grouped by 500 to constitute a hyperframe, and 500 control words are grouped by four to constitutes 125 subchannels.
